(19) United States
(12) Patent Application Publication
(10) Pub. No.: US 2011/0140838 A1
(43) Pub. Date: Jun. 16, 2011

(54) Access control system

(75) Inventor: Juan Imedio Ocaña, Fuenterrabia (ES)

(73) Assignee: Salto Systems, S.L.

(21) Appl. No.: 12/932,177

(22) Filed: Feb. 18, 2011

Related U.S. Application Data
(63) Continuation-in-part of application No. 11/047,078, filed on Jan. 31, 2005.

(30) Foreign Application Priority Data
Feb. 5, 2004 (ES) P200400254

(51) Int. Cl. G06F 7/04

(52) U.S. Cl. 340/5.54

(57) ABSTRACT

This comprises a control centre (1) via which, in a coded means of key and user identification (2) an identifying code of the means themselves, an identifying code of the user, a first set of information referring to opening operations permitted in reading means (3) for permitting access, a third set of information referring to invalidated means (2) and a second set of information, provided by reading means (3) corresponding to the different openings performed are recorded. It avoids connection between the control centre (1) and the reading means (3) with the means (2) constituting the communication means between them.

### CROSS REFERENCE TO RELATED APPLICATIONS

The present application is a Continuation in Part of copending application Ser. No. 11/047,078 filed Jan. 31, 2005, which in turn, claims priority from Spanish Application No. P200400254 filed Feb. 5, 2004. Applicant claims the benefits of 35 U.S.C. §120 as to the parent U.S. application and priority under 35 U.S.C. §119 as to the said Spanish application, and the entire disclosures of both applications are incorporated herein by reference in their entireties.

### OBJECT OF THE INVENTION

As stated in the title of this specification, this invention consists of an access control system comprising a control centre which is communicated with a plurality of readers, each of which is connected to a means of governing of a means of opening an access device to a specific place for opening or denying the opening of the access device on reading the information stored in some coded means of key and user identification according to the required needs, registering all the opening operations performed by each of the means of opening and establishing the access conditions to each of the means of opening; the aim of which is to reduce the cost of the system through the use of communication between the readers and the control centre via the coded means of key and user identification, without it being necessary for there to exist any connection between the control centre and the means of reading on the basis of those which govern the opening.

The invention is applicable to any use in which it is required to control the opening of a plurality of access devices, such as might be doors, barriers or similar, all of them through the use of a control centre, as is the case of hotels, public places, etc.

### BACKGROUND OF THE INVENTION

Centralised access control systems consist of a control centre based on a computer in which access control programs are managed as are, in some cases, means of producing electronic keys constituting coded means of key and user identification in such a way that through the use of the electronic keys the opening is permitted, according to the established access control program, of different door control points, for which purpose these points comprise reading means which are connected to a means of governing of a means of opening of an access device, in such a way that when the electronic key is read the access is permitted or denied according to the programming that has been carried out.

The coded means of key and user identification are materialised in the form of magnetic, electronic, contact or proximity cards or keys which are provided for each user so that they can open the doors by using the readers.

These access control systems must maintain data communication among the reader means, the keys and the control centre. Depending on the system used in the communication they are divided into two types: wired and autonomous.

Wired systems have the feature that the readers are connected with the control centre via a communications network, so that when an electronic key is detected in the reader, the latter asks the control centre whether it can open the door, and if so the control centre registers the opening operation in its database and includes the code of the key, the door and the date and time when the opening was made. The consultation from the reader for control purposes can also be done in deferred mode, for which the reader stores a list of authorised keys and temporarily stores the registers of openings, in such a way that the reader and the control centre periodically communicate with each other in order to exchange this data.

The operations to be carried out in the maintenance of the system consist of entering and deleting keys that are associated with each user through the use of codes, which is done very simply in these systems since it suffices to make the changes in the control centre and this passes the information on to the readers immediately. Consequently, in these systems, the keys are read-only (ROM) means of storage in which a numerical code is stored that is different for each of them.

In the case of autonomous systems, the readers are not connected to the control centre, which makes the systems cheaper and easier to install. In order to be able to function, the readers memorise the list of authorised keys, the openings performed, the permitted times, and even a calendar. In this case, a small hand-held computer is used for transporting data from the control centre, where it has been defined, to the readers, and also for gathering data from the readers on the openings made and transporting this data to the control centre. Consequently, they operate in a way similar to the wired systems in deferred mode, with the difference that the communication requires a person to physically go to all the readers using the hand-held computer. This method is not very efficient in large systems in which changes of keys, users and their authorisations are very frequent.

In order to try to reduce the number of times which the data in the readers needs to be changed in autonomous systems, provision is made so that the keys used are low-capacity read/write, so that some additional data can be stored in them permitting certain changes to be automated. Magnetic strip cards are an example of this type of key. This system is particularly effective in hotels where the most frequent change is the arrival of a new client, to whom a new key is given with the previous client's key having to be cancelled. In order to do this, clients of the same room have a common identification code and a sequential number which is incremented with each client so that the reader only accepts the key which has the latest received code and it does not open for previous clients. Also, the fact that the keys are read/write is exploited in order to add further data such as for example authorisations for using any of the hotel services, though at all times in a very limited way.

In the access control systems of the prior art, wherein there is a black list, in other words, a list of keys that do not have permitted access, if a key that is on the black list tries to open the opening means, a lock for example, that is provided with a black list, whereon the key is, said opening means rejects it not permitting access, although said key had been previously authorized. On the contrary, the present invention proposes that the opening means that a key on the black list tries to have access to, aside from not permitting access, it erases the permits that it may have to other locks that might not have an up-to-date black list, on which this key is included.

### DESCRIPTION OF THE INVENTION

In order to achieve the objectives and solve the drawbacks stated above, the invention has developed a new access control system which, as with conventional systems, comprises means of reading coded means of key and user identification, with the means of reading including means of storage of an identification code of the actual means of reading, these means of reading being connected to a means of governing of means of opening an access device to a specific place, in order to open or deny opening of the access device on reading the coded means of key and user identification; furthermore comprising a control centre for storage and management of the operating data of the system, with the coded means of key and user identification including an identifying code of the means themselves and an identifying code of the user introduced via the control centre; the invention being characterised in that the coded means of key and user identification comprise means of storage of a first set of information, provided by the control centre, and referring to the opening operations permitted to the opening means, a second set of information, provided by the reading means, referring to the different openings carried out by the means of opening, and a third set of information, provided via the control centre, referring to invalidated coded means of key and user identification, in other words, blacklists. The means of storage of the reading means store the third set of information each time the reading is carried out of a coded means of key and user identification, for which the reading means open or deny the opening on the basis of the first and third sets of information provided by the coded means of key and user identification.

This system presents the great advantage that the reading means are not connected to the control centre, which simplifies and reduces the cost of the system. Furthermore, the changes in the operating data of the reading means, along with the gathering of the register of openings that are made, are carried out automatically through the use of coded means of key and user identification, in other words, through the use of the key that is provided for the user, with which it is not necessary to use a small hand-held computer to transport data two-way between the control centre and the reading means, since this operation is carried out via the coded means of key and user identification (key), with which these means have the dual purpose of consisting of a means of identification and a means of two-way communication between the control centre and the reading means.

The coded means of key and user identification only permit access to their reading and modification for the reading means that are duly authorised to do so, in such a way that the confidentiality and invulnerability of the data are assured.

The means of storage of the reading means comprise four sets of identification information of a plurality of reading means, and the coded means of key and user identification store the four sets of information provided on the basis of the control centre, in such a way that with the same coded means of key and user identification, the opening is permitted of a plurality of means of openings corresponding to the plurality of the reading means identified by the four sets of information so that, via a single code corresponding to the four sets of information, the opening of a plurality of access devices is permitted to be made, avoiding the incorporation of every single one of the codes corresponding to the reading means of the means of opening which the user is authorised to open with the corresponding coded means of key and user identification. Obviously, the four sets of information can include one or more codes, each of which is associated with a plurality of reading means, in such a way that, through the use of a small number of codes, the opening of a large number of access devices is permitted.

Furthermore, the invention is characterised in that the coded means of key and user identification comprise a fifth set of information selected from among times and calendars corresponding to openings of access devices, provided on the basis of the control centre, for which, when a coded means of key and user identification is read, the fifth set of information is stored in the means of storage of the reading means, the opening means being opened automatically within the established times and calendar.

The third set of information referring to the coded means of key and user identification comprises a list of identifying codes of the actual coded means of key and user identification which have been invalidated (blacklists), for which, when an invalidated code is detected the opening of the corresponding access device is denied.

Besides, when a key that has an identification code that is stored in the third set of information (black list) of an opening means, tries to have access to said opening means, this opening means will not give it access. Besides it erases from the key the first set of information corresponding to the permits of access to the different opening means, in such a way that aside from not allowing access to the present opening means, it also prevents the key from having access to other opening means which have not been recently up-dated, and thus they do not have in their third set of information, the identification code of this key. Although there is still the possibility that a key that has been included on the black list has access to some of the opening means that it originally had access to, this novel system of erasing the first set of information considerably reduces the probability of this taking place.

The first set of information referring to opening operations permitted in the means of opening comprises information selected from among the identification codes of the readers to which access is permitted, the codes associated with a plurality of reading means to which access is permitted, times and calendars in which opening is permitted, information for modifying the information contained in the means of storage of the reading means and a combination thereof.

The second set of information referring to openings carried out by the means of opening comprise information selected from among the identification code of the reader which has been accessed, the user identification code, the date and time when each opening is carried out and a combination thereof.

The control centre stores the second set of information on the coded means of key and user identification when these are read in the control centre, and it eliminates that second set of information on the coded means of key and user identification, updating the content of these latest means each time they are read in the control centre.

The invention provides for the possibility of including at least one reader means, connected to the control centre for exchange of the first, second, third, fourth and fifth sets of information between the coded means of key and user identification and the control centre, in such a way that avoids the users having to go to the control centre periodically in order to carry out the exchange of information, and it suffices to carry out the reading of the coded means of key and user identification in the reading means which is connected to the control centre.

Below, in order to facilitate a better understanding of this specification and forming an integral part thereof, a series of figures is attached in which, by way of illustration only and not limiting, the object of the invention has been represented.

### BRIEF DESCRIPTION OF THE DRAWINGS

FIG. 1.—Shows a schematic view of an example of embodiment of the system of the invention.

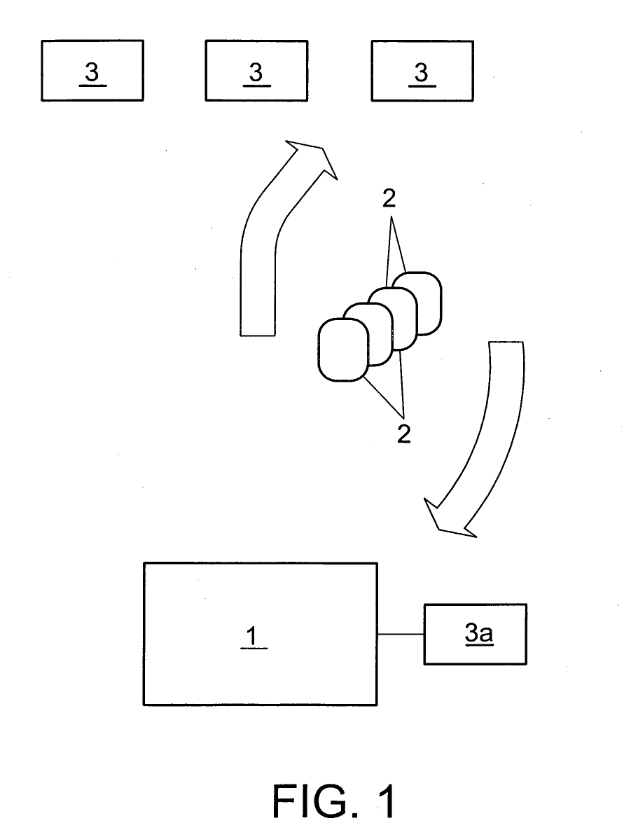

FIG. 2.—Shows a schematic view of the structuring of the storage of information in the coded means of key and user identification (electronic key) and of the exchange of information with the leading means and with the control centre.

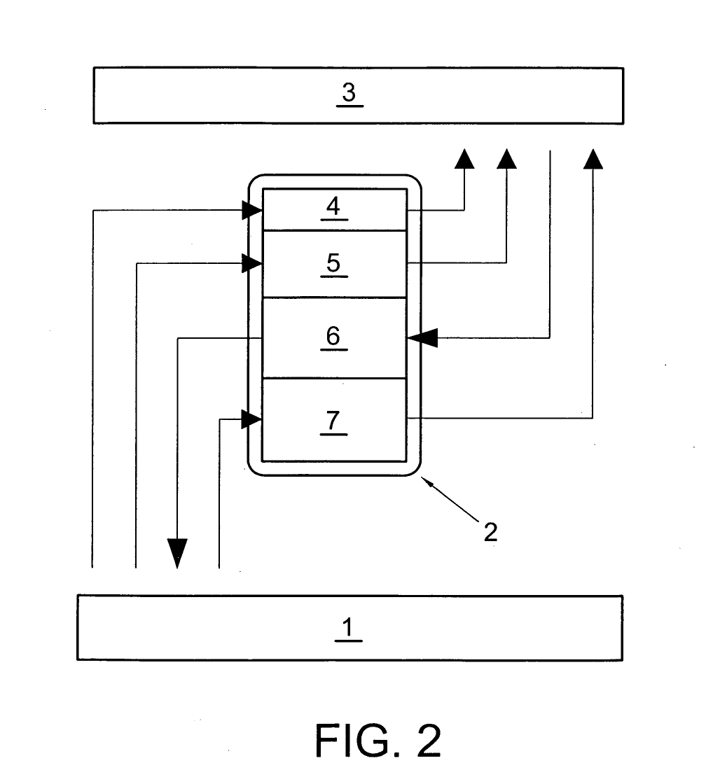

### DESCRIPTION OF AN EMBODIMENT OF THE INVENTION

Given below is a description of the invention based on the figures commented upon above.

It comprises a control centre 1, consisting of a computer which includes an access control programme for permitting the establishment of accesses authorised to the user at different access points, said program including access points, times and calendars at which access is permitted to each user.

In the example of embodiment of the invention, it is intended for the access points to be provided in the zones corresponding to the doors of a hotel, and the control centre is located in the hotel reception.

Each of the access points comprises a reader 3 which is connected to a means of governing an opening device for a door or access device. Just the reader 3 has been represented in the figure since its functioning is what differs compared to the state of the art, with the functioning of the means of governing and of the means of opening of the doors being conventional and is established on the basis of the conditions detected by the readers 3.

The readers 3 are provided with a memory in which is stored an identification code of the reader 3 itself, on the basis of which the opening of the door is denied or permitted.

Each user is granted a coded means of key and user identification 2 which can have the physical appearance of keys, tags or cards, and in the example of embodiment an electronic key 2 has been chosen, in which an identification code of that key is stored which has previously been recorded in a memory zone 4 of the electronic key 2.

In order to assign the key to a user, the operator introduces the user data into the control centre 1 and gives him authorisations for opening certain doors within certain established times and calendar, which corresponds to the first set of information described in the section on description of the invention, in such a way that the control centre 1 assigns a user code to him which it stores in the memory zone 4 together with the identification code of the key.

As a consequence, the first set of information referring to the authorisations for opening certain doors comprise the identification code of the reader along with the times and calendars in which the opening is permitted, in such a way that, when the key 2 is presented in the readers 3, the latter verify the identification of the reader, the time and calendar, and they permit or deny opening depending on the data read. This first set of information is recorded in zone 5 of key 2.

The means of communication of the keys with the reader can be, for example, via contacts (SmartCard ISO 7816), by proximity (ISO 14443; ISO 15693) or by radiofrequency.

Each time an opening is carried out, the reader 3 records the second set of information in a memory zone 6 of the electronic key 2. The second set of information is made up of the time and date on which the opening is made, the identification code of the reader and the identification code of the user.

So, the readers permit or deny the opening of the door depending on the information contained in the key, and the different operations performed by the keys are stored in the key itself, with which the readers 3 do not need to be connected to the control centre 1 since the information required for carrying out the openings is contained in the key 2, and furthermore the information referring to the openings performed is likewise again stored in the key, on the basis of which the control centre 1 obtains the different operations carried out by each key, storing this data for its control.

In the event that the user loses his key, he is assigned another, and in this case the data stored in the new key will correspond to that of the previous key, though with the difference that the key code is different. In this situation, also stored in the new key, in its memory zone 5, is the identification code of the mislaid key. The identification code of other mislaid or non-authorised keys can also be stored there, due to which in that memory zone 5 of the key 2 is stored the first set of information and the blacklist of keys for which no access is permitted and which constitute the third set of information, in such a way that those keys cannot be used fraudulently since each time a reader reads a key, it reads the blacklist of keys which, for one reason or another, have been cancelled in the system. In this way, the reader stores the third set of information corresponding to the blacklist and it updates it in each reading, so, when it detects a key identification code that is included in the blacklist, it refuses to open the door.

Therefore, when a user uses the readers 3, the previous key becomes cancelled, and likewise the cancelled keys of other users are stored in the readers 3, so the cancellation of lost keys is spread faster.

Hence, when a user having an unauthorized key tries to have access to the lock which another user has opened updating the black list and thus including this key on its black list, aside from said lock with the list updated not permitting access thereto, it will erase the first set of information of the key in such a way that it does not have access to the rest of the opening means to which the invalid key originally had access to.

So, the present invention in a preferred embodiment comprises reading means for key coded means and user identification means including said reading means storage means of its own identification code, and being connected to governing means of opening means of an access device. It also comprises a control centre for storage and management of the operating data of the system and the key coded means and user identification means include an identifying code of the means themselves and an identifying code of the user, introduced via the control centre. The key coded means and user identification means comprise storage means of a first set of information, provided by the control centre and referring to the permitted opening operations of the opening means, a second set of information, provided by the reading means, referring to different openings and a third set of information, provided via the control centre, referring to invalidated key coded means and user identification means (blacklist). The third set of information is stored by the reading means each time a key coded means and user identification means are read, in order to allow the reading means to open or deny the opening on the basis of the first and third sets of information provided by the key coded means and user identification means. This preferred embodiment of the invention also comprises opening means which comprises in turn deleting means of the first set of information of the key coded means whose key coded means and user identification means belong to an invalid user, in order to restrict the access of the key to the opening means which it originally had access to.

Furthermore, the readers can finally store a fourth set of information corresponding to the identification of a plurality of reading means, in other words, zone codes which they share with other readers of the same zone. This permits the user's plan of locking to be simplified since, in order to give authorisation for access to several readers constituting a zone, instead of numbering all the reader identification codes it suffices to give just the zone code which includes them for carrying out opening of the doors corresponding to those readers. The zone codes authorised to a person are stored in zone 5 of the key 2, together with the first and second sets of information mentioned earlier.

It can be pointed out that memory zone 6, as well as storing the different openings carried out by the key, also stores certain maintenance events for the readers, such as low battery warning.

Furthermore, the readers can memorise a fifth set of information referring to some particular piece of data which they need for activities that do not depend on reading the keys, such as times and calendars for carrying out automatic openings of doors. When that fifth set of information is modified in the control centre 1, it is recorded in a memory zone 7 of the keys 2 as commands addressed to one or more specific readers. When the reader reads the key 2 it gathers data from the memory zone 7 and saves it in its means of storage of the fifth set of information.

Also stored in memory zone 7 of the keys 2 are commands addressed to one or more specific readers for modifying any of their particular data, and as a consequence this memory zone is only necessary if the reader has some particular piece of data such as might be the times of automatic opening, and they need to be modified.

As a consequence, and according to the description made, it can be understood that the memory zones 5, 6 and 7 of the key 2 constitute the two-way means of communication between the readers and the control centre 1; the memory zones 5 and 7 constitute communication in the direction from the control centre to the readers and memory zone 6 constitutes the communication sector in the opposite direction, in other words, from the readers 3 to the control centre 1.

The invention also provides for the possibility of the readers being connected to the control centre 1 in order to make the functioning of the system more flexible and avoid users having to go to the control centre 1 periodically in order to alter the data stored in their keys 2.

The reader 3a is known as the updater, and it controls access to a door like any other reader 3, but it also has the capacity for changing the data in the keys thanks to its being connected to the control centre 1. Furthermore, the updaters 3a empty the data stored in the keys and send it to the control centre 1. This process is entirely transparent for the user since when he performs an opening, communication is made with the control centre 1 in order to update the data in the manner already described. Each facility can have an updater 3a or several of them in the event of the facility being very large, in such a way that the benefits of a wired network are obtained with the invention.

When the key is read in an updater 3a, the latter withdraws all the registers of the key and stores them in its database. Furthermore, it modifies the

data corresponding to the locking plan and to the blacklist stored in the memory zone 5 if changes have been made since the last time and it saves in zone 7 the commands to the readers if their particular data has been modified.

1. ACCESS CONTROL SYSTEM, comprising
reading means for key coded means and user identification means,
the reading means including storage means of its own identification code,
said reading means being connected to governing means of opening means of an access device;
a control centre for storage and management of the operating data of the system,
the key coded means and user identification means including an identifying code of the means themselves and an identifying code of the user, introduced via the control centre; wherein
the key coded means and user identification means comprise storage means of
a first set of information, provided by the control centre and referring to the permitted opening operations of the opening means,
a second set of information, provided by the reading means, referring to different openings,
and a third set of information, provided via the control centre, referring to invalidated key coded means and user identification means (blacklist); the third set of information being stored by the reading means each time a key coded means and user identification means are read, in order to allow the reading means to open or deny the opening on the basis of the first and third sets of information provided by the key coded means and user identification means;
deleting means of the first set of information whose key coded means and user identification means belong to an invalid user, to restrict the access of the key to the opening means which it originally had access to.

2. ACCESS CONTROL SYSTEM, according to claim 1, wherein
the storage means of the reading means comprise a fourth set of information for identifying a plurality of reading means;
the key coded means and user identification means store the fourth set of information, provided by the control centre, in order to permit opening of the opening means corresponding to the plurality of the reading means identified by the fourth set of information, all this via the same key coded means and user identification means once read by the corresponding reading means.

3. ACCESS CONTROL SYSTEM, according to claim 1, wherein the key coded means and user identification means comprise a fifth set of information selected from among timetables and calendars corresponding to openings of access devices; and in that the storage means of the reading means store the fifth set of information when reading the key coded means and user identification means, in order to automatically open the opening means.

4. ACCESS CONTROL SYSTEM, according to claim 1, wherein the third set of information referring to the key coded means and user identification means comprises a list of identifying codes of the key coded means and user identification means which have been invalidated.

5. ACCESS CONTROL SYSTEM, according to claim 2, wherein the fourth set of information comprises at least one code, each of which is associated with a plurality of reading means.

6. ACCESS CONTROL SYSTEM, according to claim 1, 4 or 5, wherein the first set of information referring to permitted opening operations in the opening means comprises information selected from the identification codes of the readers to which access is permitted, the codes associated to a plurality of reading means to which access is permitted, timetables and calendars in which opening is permitted, information for modifying the information contained in the storage means of the reading means and combinations thereof.

7. ACCESS CONTROL SYSTEM, according to claim 1, wherein the second set of information referring to different openings carried out by the opening means comprises information selected from the identification code of the reader which has been accessed, a user identification code, date and time at which each opening has been carried out and combinations thereof.

8. ACCESS CONTROL SYSTEM, according to previous claims, wherein the control centre stores the second set of information of the key coded means and user identification means when these are read in the control centre, and it eliminates said second set of information of the key coded means and user identification means.

9. ACCESS CONTROL SYSTEM, according to claim 1, wherein at least one of the reading means is connected to the control centre for exchange of the first, second, third, fourth and fifth sets of information between the key coded means and user identification means, and the control centre.
